(19) United States
(12) Patent Application Publication
(10) Pub. No.: US 2008/0293608 A1
(43) Pub. Date: Nov. 27, 2008

(54) Composition and Method

(75) Inventors: Sebastian Drossmann, Hemsbach (DE); Judith Preuschen, Ludwigshafen (DE); Ralf Wiedemann, Mira VE (IT)

Correspondence Address: NORRIS, MCLAUGHLIN & MARCUS, 875 THIRD AVE, 18TH FLOOR, NEW YORK, NY, 10022, US

(73) Assignee: Reckitt Benckiser N.V., Hoofddorp (NL)

(21) Appl. No.: 12/095,156

(22) PCT Filed: Dec. 7, 2006
(86) PCT No.: PCT/GB06/04570

§ 371 Date: Jun. 23, 2008

(30) Foreign Application Priority Data
Dec. 7, 2005 (GB) 0524927.1

(51) Int. Cl. C11D 3/386

(52) U.S. Cl. 510/226

(57) ABSTRACT

A filter cleaning composition for use between dishwashing operations in a dishwasher, the composition comprising at least one non-starch carbohydrase, for example a cellulase. A method of using said composition is also disclosed.

### TECHNICAL FIELD

This invention relates to a filter-cleaning composition for use in automatic dishwashing machines, and a method of using said composition.

### BACKGROUND AND PRIOR ART

Automatic dishwashing (ADW) machines commonly have a filter built in to capture soils. Typically these filters capture soils having a size of or greater than about 1 mm. Users should remove and clean the filter frequently. However many do not do this and so the captured soil particles remain on the filter. Some will be washed away over time, but others will remain on the filter and decay, and can cause bad odours. In addition to the formation of bad odours, soil particles may clog the filter. This may cause problems with the circulation of the wash and rinse waters leading to poor cleaning results.

If a filter is not cleaned frequently, the soils present may become harder to remove, further increasing the consumer's reluctance to do so. They may also become more malodorous.

Machine cleaning tablets, e.g. for use in automatic dishwashers, are known from e.g. US2003/0032568. Cleaning compositions which may be used in automatic dishwashers are known e.g. from WO98/39402. The use of enzymes to clean filters during the production of beer is known from WO98/39402, WO96/23579 and WO98/51776.

It is an object of the present invention to provide a solution to at least some of the above-referenced problems.

### STATEMENT OF INVENTION

According to a first aspect of the invention, there is provided a filter cleaning composition for use between dishwashing operations in a dishwasher, the composition comprising at least one non-starch carbohydrase.

According to a second aspect of the invention, there is provided a method of cleaning the filter of an automatic dishwasher between dishwashing operations, the method comprising contacting the filter with a composition as claimed in any preceding claim, including with a diluted from thereof, for a period of at least 30 minutes.

According to the third aspect of the present invention, there is provided a product comprising a container and dispensing means, wherein the container comprises a composition according to the first aspect.

According to the fourth aspect of the present invention, there is provided the use, in between washes, of a composition comprising a non-starch carbohydrase to degrade soils in an automatic dishwashing machine.

Thus, in accordance with the present invention the filter cleaning composition is used between dishwashing operations; that is, between regular operations of the dishwasher to wash kitchenware, for example dishes, cutlery and the like. The composition of the present invention is added when the dishwasher is empty of kitchenware.

In one embodiment the composition is delivered to the dishwasher and the dishwasher is not operated. The composition is washed from the dishwasher during the next regular operation of the dishwasher (hereinafter a “filter-specific cleaning embodiment”).

In another embodiment the composition is delivered to the dishwasher as a dishwasher cleaning composition (hereinafter a “machine/filter cleaning embodiment”). Such a composition is delivered to the machine and the machine is operated, but in a dummy cycle, i.e. without kitchenware being present. The whole machine may thereby be cleaned, including the filter, in accordance with this invention.

The purpose of the composition of the invention is to degrade tough soils which may otherwise be difficult to remove from the filter. Soils which can be broken down by the composition of the invention include cereals, fruits and vegetables. Some specific examples include lettuce, asparagus, full-grain bread, orange and lemon peels, apple pieces and spinach.

Once degraded the soils may pass easily through the filter and be washed away. In the case of a filter-specific cleaning embodiment this will be during the next regular dishwashing operation of the dishwasher. In the case of a machine/filter cleaning embodiment this will be during the outflow of water during the dummy cycle of the dishwasher operation.

The filter-specific cleaning embodiment is preferred and in such an embodiment the composition of the present invention is typically applied to the dishwasher and left for a prolonged period when the dishwasher is not in use. For example, the composition may be applied to the filter and the dishwasher left, until it is next needed. Preferably the dishwasher is empty of kitchenware. This method of using the composition is discussed further below.

Percentage definitions are given below. In this specification a reference to the percentage amount of the defined component is to its percentage by weight on the total weight of the composition, unless otherwise stated. References in this specification to a component, for example a non-starch carbohydrase, embrace the possibility that there may be only one such component present, or more than one. When a percentage value is stated for a component in a general definition given herein, including in any claim, that value denotes the total amount present, when more than one such component is present. For example when we state that there may suitably be present at least 0.01% of a non-starch carbohydrase active enzyme, this figure denotes the total amount of non-starch carbohydrase active enzymes present, when there is more than one; unless otherwise stated.

### DETAILED DESCRIPTION

Preferably the composition comprises at least 0.01 wt % of non-starch carbohydrase active enzyme. Preferably it contains at least 0.1 wt % active enzyme, more preferably at least 0.3 wt % active enzyme, most preferably at least 0.5 wt % of non-starch carbohydrase active enzyme.

Preferably the composition comprises up to 20 wt % non-starch carbohydrase active enzyme(s), preferably up to 15 wt %, more preferably up to 10 wt % and most preferably up to 5 wt %. It is most preferred that the composition comprises 0.1 to 2 wt % of non-starch carbohydrase.

A preferred composition contains at least two non-starch carbohydrases.

When first and second non-starch carbohydrase(s) are present, the composition preferably comprises at least 0.01 wt %, preferably at least 0.1 wt %, more preferably at least 0.3 wt % and most preferably at least 0.5 wt % of the first non-starch carbohydrase; and at least 0.01 wt %, more preferably at least 0.1 wt %, more preferably at least 0.3 wt % and most preferably at least 0.5 wt % of the second non-starch carbohydrase.

In terms of non-starch carbohydrase active enzyme per unit dose of composition the amount is preferably at least 10 mg, more preferably at least 50 mg; and preferably up to 100 mg.

A suitable non-starch carbohydrate is a xylanase and, especially, a cellulase. When there are two (or more) non-starch carbohydrases there are suitably at least two cellulases or at least one cellulase and at least one xylanase.

Suitable non-starch carbohydrase(s) for use in the present invention include those sold under the trade marks; Multifect CEG, IndiAge MAX G, GC 220, GC 880, Primafast 200, Celluzyme 0.7T, IndiAge Neutra G, Carezyme 4500 T, Novozym 342, Multifect Xylanase, Multifect 720 and IndiAge RFW.

Preferred non-starch carbohydrase(s) for use in this invention are sold under the trade names; Multifect CEG, Multifect 720, Novozym 342 and Celluzyme 0.7T. In preferred embodiments the composition comprises both Multifect CEG and, preferably, Celluzyme 0.7T. In an especially preferred embodiment, the composition comprises 0.5 to 1.5 wt % Multifect CEG and 0.5 to 1.5 wt % Celluzyme 0.7T as supplied.

Preferably the pH of the composition is less than 10. More preferably the composition is acidic. Preferably the pH is less than 6, more preferably it is less than 5. In preferred embodiments the composition has a pH of between 3 and 6, more preferably of between pH 3 and 5. In another embodiment the pH may suitably be from 7 to 9. The pH values herein are ones obtained when the composition is added to deionised water in a ratio of 1:100 (vol:vol) at 20° C.

The pH of the composition may be adjusted by the addition of acid or base (for example, sodium (bi)carbonate, in some circumstances).

Preferably the composition comprises an organic acid. More preferably it comprises a polycarboxylic acid, preferably having 1 to 5 carbon atoms. Most preferably it comprises citric acid. The acid or base is present in an amount sufficient to maintain the pH of the composition within a desired range.

The composition may be in any suitable form, for example a foam, a liquid or a gel. Preferably the composition is an aqueous composition although any suitable solvent may be used. Alternatively, the composition may be supplied as a powder or tablet or soluble sachet, for example a sachet having a polyvinyl alcohol wall.

Preferably the composition comprises at least 50 wt % water, preferably at least 70 wt %, more preferably at least 90 wt % and most preferably at least 95 wt % water.

Preferably the composition is in the form of a viscous liquid or gel.

Preferably the composition has a viscosity of at least 50 mPas when measured with a Brookfield RV Viscometer at 25° C. with Spindle 1 at 30 rpm in such cases the composition is preferably a liquid.

Preferably the composition comprises a viscosity modifier, e.g., a thickener which increases the viscosity of the cleaning composition. Preferably a viscosity modifier is present in an amount of at least 0.1 wt %, preferably at least 0.2 wt %. Preferably the composition comprises up to 3 wt % of a viscosity modifier, more preferably up to 2 wt %.

Exemplary viscosity modifiers include polycarboxylate polymers, polyacrylamides, clays, and mixtures thereof.

Preferably the composition further comprises an odour-control agent. This is to combat any malodour which may develop in the dishwasher due to decaying soils or bacteria.

Suitable odour-control agents include enzymes such as oxidases for example laccases and glucose-oxidases which can generate hydrogen peroxide in situ; or an alternative source of hydrogen peroxide.

A preferred odour-control agent is a glucose-oxidase. This is preferably present in an amount of at least 0.1 wt %, preferably at least 0.4 wt %. Preferably it is present in an amount up to 5 wt %, preferably up to 2 wt %.

Preferably the composition includes a fragrance, suitably at least 0.01 wt %, preferably at least 0.05 wt %, thereof; suitably up to 1 wt %, preferably up to 0.3 wt %.

The composition may include a preservative. Exemplary preservatives which may form part of the composition include useful water soluble or water dispersible compositions which include terpenes and parabens, including methyl parabens and ethyl parabens, glutaraldehyde, formaldehyde, 2-bromo-2-nitropropoane-1,3-diol, 5-chloro-2-methyl-4-isothiazolin-3-one, 2-methyl-4-isothiazoline-3-one, and mixtures thereof.

The composition may include further anti-microbially effective agents, such as a biocide, e.g., pyrithiones (especially zinc pyrithione which is also known as ZPT), dimethyldimethylol hydantoin (available under the tradename Glydant), methylchloroisothiazolinone/methylisothiazolinone (available under the tradename Kathon CG), sodium sulphite, sodium bisulphite, imidazolidinyl urea (available under the tradename Germall 115), diazolidinyl urea (available under the tradename Germaill II), benzyl alcohol, 2-bromo-2-nitropropane-1,3-diol (available under the tradename Bronopol), formalin (formaldehyde), iodopropenyl butylcarbamate (available under the tradename Polyphase P100), chloroacetamide, methanamine, methyldibromonitrile glutaronitrile (1,2-dibromo-2,4-dicyanobutane or available under the tradename Tektamer), glutaraldehyde, 5-bromo-5-nitro-1,3-dioxane (available under the tradename Bronidox), phenethyl alcohol, o-phenylphenol/sodium o-phenylphenol, sodium hydroxymethylglycinate (available under the tradename Suttocide A), polymethoxy bicyclic oxazolidine (available under the tradename Nuosept C), dimethoxane, thimersal dichlorobenzyl alcohol, captan, chlorphenenesin, dichlorophene, chlorbutanol, glyceryl laurate, halogenated diphenyl ethers like 2,4,4-trichloro-2-hydroxy-diphenyl ether (available under the tradename Triclosan or TCS), 2,2-dihydroxy-5,5-dibromo-diphenyl ether, phenolic anti-microbial compounds like phenol, phenols substituted by C₁₋₈ alkyls group(s) and/or by halogen atom(s) and/or by benzyl group(s), resorcinol and its derivatives, 5-chloro 2,4-dihydroxydiphenyl methane, 4-chloro 2,4-dihydroxydiphenyl methane, 5-bromo 2,4-dihydroxydiphenyl methane, and 4-bromo 2,4-dihydroxydiphenyl methane, bisphenolic compounds like 2,2-methylene bis(4-chlorophenol), 2,2-methylene bis(3,4,6-trichlorophenol), 2,2-methylene bis(4-chloro-6-bromophenol), bis(2-hydroxy-3,5-dichlorophenyl) sulphide, and bis(2-hydroxy-5-chlorobenzyl)sulphide, benzoic esters (parabens) like methylparaben, propylparaben, butylparaben, ethylparaben, isopropylparaben, isobutylparaben, benzylparaben, sodium methylparaben, and sodium propylparaben, halogenated carbanilides (e.g., 3,4,4-trichlorocarbanilides (available under the tradename Triclocarban or TCC), 3-trifluoromethyl-4,4-dichlorocarbanilide or 3,3,4-trichlorocarbanilide.

The composition of the present invention preferably comprises less than 10 wt % surfactant, preferably less than 5 wt %, more preferably less than 1 wt % and most preferably less than 0.7 wt %.

A surfactant is preferably present in an amount up to 5 wt %. Preferred compositions comprise 0.1 to 4 wt % surfactant.

Suitable surfactants are anionic, non-ionic, cationic or amphoteric surfactants, or mixtures thereof. Many such surfactants are described in Kirk Othmer's Encyclopedia of Chemical Technology, 3rd Ed., Vol. 22, pp. 360-379, “Surfactants and Detersive Systems”, incorporated by reference herein. In general, bleach-stable surfactants are preferred. Non-ionic surfactants are especially preferred.

One possible class of nonionic surfactants are ethoxylated non-ionic surfactants prepared by the reaction of a monohydroxy alkanol or alkylphenol with 6 to 20 carbon atoms with preferably at least 12 moles particularly preferred at least 16 moles, and still more preferred at least 20 moles of ethylene oxide per mole of alcohol or alkylphenol.

Particularly preferred non-ionic surfactants are the non-ionics from a linear chain fatty alcohol with 16-20 carbon atoms and at least 12 moles particularly preferred at least 16 and still more preferred at least 20 moles of ethylene oxide per mole of alcohol.

According to one preferred embodiment of the invention, the non-ionic surfactants additionally comprise propylene oxide units in the molecule. Preferably this PO units constitute up to 25% by weight, preferably up to 20% by weight and still more preferably up to 15% by weight of the overall molecular weight of the non-ionic surfactant. Particularly preferred surfactants are ethoxylated mono-hydroxy alkanols or alkylphenols, which additionally comprises polyoxyethylene-polyoxypropylene block copolymer units. The alcohol or alkylphenol portion of such surfactants constitutes more than 30%, preferably more than 50%, more preferably more than 70% by weight of the overall molecular weight of the non-ionic surfactant.

Another class of suitable non-ionic surfactants includes reverse block copolymers of polyoxyethylene and polyoxypropylene and block copolymers of polyoxyethylene and polyoxypropylene initiated with trimethylolpropane.

Another preferred class of nonionic surfactant can be described by the formula:

R¹O[CH₂CH(CH₃)O]_{X}[CH₂CH₂O]_{Y}[CH₂CH(OH)R²]

where R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred nonionic surfactants are the end-capped polyoxyalkylated non-ionics of formula:

R¹O[CH₂CH(R³)O]_{X}[CH₂]ₖCH(OH)[CH₂]ⱼOR²

where R¹ and R² represent linear or branched chain, saturated or unsaturated, aliphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R³ in the formula above can be different. R¹ and R² are preferably linear or branched chain, saturated or unsaturated, aliphatic or aromatic hydrocarbon groups with 6-22 carbon atoms, where group with 8 to 18 carbon atoms are particularly preferred. For the group R³H, methyl or ethyl are particularly preferred. Particularly preferred values for x are comprised between 1 and 20, preferably between 6 and 15.

As described above, in case x>2, each R³ in the formula can be different. For instance, when x=3, the group R³ could be chosen to build ethylene oxide (R³═H) or propylene oxide (R³=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R¹O[CH₂CH(R³)O]ₓCH₂CH(OH)CH₂OR²

The use of mixtures of different nonionic surfactants is suitable in the context of the present invention for instances mixtures of alkoxylated alcohols and hydroxy group containing alkoxylated alcohols.

The composition may comprise other optional excipients for example dyes, stabilizers, and further enzymes. Suitably dyes may include food grade dyes such as Ultramarin Blue and Patentblau from Clariant. Further enzymes may be present, which may be selected from, for example, lipases, proteases and amylases. Such further enzymes may suitably be present in an amount from 0.1 to 3 wt %, preferably 0.5 to 2 wt %.

The composition may further comprise builders, for example selected from alkali metal salts of phosphates, phosphonates, citrates, silicates, disodium methyl glycine diacetate (MGDA), tetrasodium imino-disuccinate or disodium glutamic-N,N-diacetate; suitably from 1 to 20 wt % thereof, preferably 2 to 10%.

The composition may be in the form of a foam, liquid or gel. It may be applied by any available means, for example a trigger spray, squeeze bottle or an aerosol.

The composition of the present invention is particularly suitable for cleaning the filters which retain soil particles in automatic dishwashers. However, it may also be applied to other areas of the dishwasher machine where stubborn soils have deposited.

According to the second aspect of the present invention, there is provided a method of cleaning the filter of an automatic dishwasher between regular dishwashing operations, the method comprising contacting the filter with the composition of the first aspect (including with a diluted form thereof) for a period of at least 30 minutes.

To conclude the method the composition may be rinsed from the dishwasher.

Preferably the contact time with the filter is at least 1 hour.

A preferred method is a filter cleaning method, as defined above. In this embodiment the composition is washed out of the dishwasher when it is next used in a regular dishwashing operation, whether that be 2 hours, 12 hours or 24 hours later. Preferably the composition is delivered to the dishwasher shortly after the end of the previous dishwashing operation, to maximise the residence time. It is thus preferred that the composition is applied to the filter without the dishwasher being operated.

In the preferred filter-specific cleaning embodiment the composition is left in the dishwasher for a period of at least 2 hours, more preferably at least 4 hours. Suitably it may be left overnight. Preferably the composition is left in the dishwasher for a period of less than 48 hours, preferably less than 36 hours, more preferably less than 24 hours.

In the filter-specific cleaning embodiment the composition may be applied directly to the filter or it may be applied liberally throughout the dishwasher and allowed to drain into the filter.

An alternative is a machine/filter cleaning embodiment as defined above.

In the machine/filter cleaning embodiment the composition is distributed throughout the cavity of the dishwasher by the spray mechanism in a dummy wash; but at any given time there will be contact with the filter and of course the water containing the composition must drain through the filter.

According to the third aspect of the present invention, there is provided a product comprising a container and dispensing means, wherein the container comprises a composition according to the first aspect.

The dispensing means allows delivery of the composition to a locus, and may suitably comprise a nozzle, spout or tapered opening.

In preferred embodiments in which the composition is in the form of a thick viscous liquid, it may be poured directly onto the filter. It may, for example, be dispensed from a bottle shaped to aid pouring or a tube or a bottle adapted to be squeezed in order to release the contents.

According to the fourth aspect of the present invention, there is provided the use, in between washes, of a composition comprising a non-starch carbohydrase to degrade soils in an automatic dishwashing machine.

The invention will now be further described by way of the following non-limiting examples.

### EXAMPLES

### Example 1

A solution was prepared comprising the following components:

| | | |
|---|---|---|
| Celluzyme 0.7 T (ex. Novozyme) | 1 | wt % |
| Multifect CEG (ex. Genencor) | 1 | wt % |
| Dye (Patent Blue, E131, ex. BASF) | 0.1 | wt % |
| Surfactant (Plurafac LF 500) | 0.5 | wt % |
| Thickener (Hostagel ex. Clariant) | 0.3 | wt % |
| Biocide (Kathon CG ex. Rhom & Haas) | 0.09 | wt % |
| Fragrance | 0.1 | wt % |

| | |
|---|---|
| Citric acid | sufficient to provide a solution |
| | of pH 4 (once water added) |
| Deionised water | Balance |

(Celluzyme, Multifect CEG, Plurafac, Hostagel and Kathon are tradenames)

Red fruit tea was added to the solution and the mixture was stirred at room temperature for 20 hours.

After this period, complete degradation of the fruit tea was observed.

The fruit tea consisted of distinct pieces of apple, strawberry and dog rose, and wooden particles, at the start of the experiment. At the end of the experiment the fruit tea was degraded into a pulpy consistency, which was powdery after drying.

This clearly shows that the composition would degrade fruit tea sufficiently to allow it to be washed away during the next normal working operation of an ADW machine.

### Example 2

A solution was prepared which was the same as in Example 1, but in which the citric acid was absent, and sufficient sodium carbonate was added to provide a solution of pH 8.

Red fruit tea was added to the solution and the mixture was stirred at room temperature for 20 hours.

Again, after this period, complete degradation of the fruit tea was observed, into a pulp mass able to be washed away during the next normal working operation of an ADW machine.

1. A filter cleaning composition adapted for use between dishwashing operations in a dishwasher, the composition comprising at least one non-starch carbohydrase.

2. A composition according to claim 1 which comprises at least two non-starch carbohydrases.

3. A composition according to claim 1 which comprises at least 0.1-2 wt % of non-starch carbohydrase.

4. A composition according to claim 1 wherein the non-starch carbohydrase is selected from cellulase and xylanase.

5. A composition according to claim 1, which composition is acidic.

6. A composition according to claim 1 which yields a solution of pH of 3 to 6 when diluted 1:100 in deionised water at 20° C.

7. A composition according to claim 1 which has a pH of 7 to 9 when diluted 1:100 in deionised water at 20° C.

8. A composition according to claim 1 which comprises at least 90 wt % water.

9. A composition according to claim 1 which further comprises an odour-control agent.

10. A composition according to claim 9 which comprises glucose oxidase.

11. A composition according to claim 1 which comprises a biocide.

12. A composition according to claim 1 which comprises a fragrance.

13. A composition according to claim 1 which comprises a thickener.

14. A composition according to claim 1 wherein the composition is a liquid of viscosity of at least 50 mPas as determined by the method described herein.

15. A method of cleaning the filter of an automatic dishwasher between dishwashing operations, the method comprising contacting the filter with a composition according to claim 1, optionally a diluted from thereof, for a period of at least 30 minutes.

16. A method as claimed in claim 15, wherein the composition is applied to the filter without the dishwasher being operated.

17. A method according to claim 16 wherein the composition is left for at least 4 hours before being washed from the dishwasher.

18. A method according to claim 15, wherein the composition is put in the machine for a dummy dishwashing cycle.

19. A product comprising a container and dispensing means, wherein the container comprises a composition according to claim 1.

20. A method for degrading soils retained by a filter of an automatic dishwasher, the method comprising the step of providing a composition comprising a non-starch carbohydrase to degrade soils retained by a filter of the dishwasher.
